(19) United States
(12) Patent Application Publication
(10) Pub. No.: US 2024/0221052 A1
(43) Pub. Date: Jul. 4, 2024

(54) SYSTEMS AND METHODS FOR NEXT BEST ACTION PREDICTION

(71) Applicant: Walmart Apollo, LLC, Bentonville, AR (US)

(72) Inventors: Divya Chaganti, San Jose, CA (US); Shubham Yograj Thakur, San Francisco, CA (US); Hyun Duk Cho, San Francisco, CA (US); Sushant Kumar, San Jose, CA (US); Kannan Achan, Saratoga, CA (US)

(21) Appl. No.: 18/092,059

(22) Filed: Dec. 30, 2022

(51) Int. Cl. G06Q 30/0601; G06Q 30/0201

(52) U.S. Cl. CPC G06Q 30/0631; G06Q 30/0201; G06Q 30/0633

(57) ABSTRACT

Systems and methods of generating an interface including one or more assets selected by an asset prediction model are disclosed. A user identifier associated with a set of user features and a set of assets each including a set of asset features is received and a set of predicted assets is generated using a trained asset prediction model. The trained asset prediction model comprises a machine learning model configured to receive the set of user features and the set of asset features for each asset in the set of assets and output the set of predicted assets and the trained asset prediction model is configured to maximize a likelihood of engagement for the set of predicted asset. An interface including a predetermined number of assets selected from the set of predicted assets in descending ranked order is generated.

### TECHNICAL FIELD

This application relates generally to interface generation and, more particularly, to asset prediction.

### BACKGROUND

Current interfaces can include a large number of engagement assets that are configured to provide information, interactions, and/or prompt additional actions. The engagement assets can be distributed across multiple pages or sub-interfaces. The location of certain assets may not be readily apparent from the interface design and/or may be accessible only through certain portions of the interface.

Certain assets can provide high engagement opportunities if presented to certain users of an interface. Current interfaces do not prioritize contextually or user-appropriate assets, instead having fixed structures that require certain interactions with the interface in order to reach relevant assets. Although some interfaces provide explore mechanics for surfacing potentially relevant assets, the presentation of such assets is not targeted, or tailored, to individual users or systems.

### SUMMARY

In various embodiments, a system including a non-transitory memory configured to store instructions thereon and a processor is disclosed. The processor is configured by the instructions to receive a user identifier associated with a set of user features, receive a set of assets each including a set of asset features, generate a set of predicted assets using a trained asset prediction model, and generate an interface including a predetermined number of assets selected from the set of predicted assets in descending ranked order. The trained asset prediction model comprises a machine learning model configured to receive the set of user features and the set of asset features for each asset in the set of assets and output the set of predicted assets. The trained asset prediction model is configured to maximize a likelihood of engagement for the set of predicted assets.

In various embodiments, a computer-implemented method is disclosed. The method includes the steps of receiving a set of user features, receiving a set of features for each of a plurality of assets, executing a trained asset prediction model to generate a set of ranked assets, and generating an interface including a predetermined number of assets selected from the set of ranked assets in descending ranked order. The trained asset prediction model is configured to receive the set of user features and the set of asset features for each asset in the plurality of assets and output the set of ranked assets. The trained asset prediction model is configured to maximize a likelihood of engagement for the set of ranked assets.

In various embodiments, a method of training an asset prediction model is disclosed. The method includes the steps of receiving a set of training data including a set of user-preference features associated with a plurality of user identifiers, a set of asset features associated with a plurality of assets, and a set of user-asset interaction features associated with interactions between the plurality of users and the plurality of assets, iteratively modifying one or more parameters of an asset prediction model to minimize a predetermined cost function, wherein the asset prediction model includes balanced weights, and outputting a trained asset prediction model configured to receive at least one user identifier and a plurality of assets and generate a set of ranked assets.

### BRIEF DESCRIPTION OF THE DRAWINGS

The features and advantages of the present invention will be more fully disclosed in, or rendered obvious by the following detailed description of the preferred embodiments, which are to be considered together with the accompanying drawings wherein like numbers refer to like parts and further wherein:

FIG. 1 illustrates a computer system configured to implement one or more processes, in accordance with some embodiments.

FIG. 2 illustrates a network environment configured to provide an interface having one or more assets generated by a next best asset prediction system, in accordance with some embodiments.

FIG. 3 illustrates an artificial neural network, in accordance with some embodiments.

FIG. 4 illustrates a tree-based neural network, in accordance with some embodiments.

FIG. 5 is a flowchart illustrating a method of generating an interface including at least one predicted asset, in accordance with some embodiments.

FIG. 6 is a process flow illustrating various steps of the method of generating an interface of FIG. 5, in accordance with some embodiments.

FIG. 7 illustrates a method for generating a trained asset prediction model in accordance with some embodiments.

FIG. 8 is a process flow illustrating various steps of the method of generating a trained asset prediction model of FIG. 7, in accordance with some embodiments.

FIG. 9 illustrates a process flow of a trained machine learning model configured to provide next best action prediction, in accordance with some embodiments.

FIG. 10 illustrates a next best action prediction platform architecture, in accordance with some embodiments.

FIG. 11 illustrates an interface including predicted assets selected by an asset prediction model, in accordance with some embodiments.

FIG. 12 illustrates an NBA offer interface architecture 700, in accordance with some embodiments.

FIG. 13 illustrates a model architecture of a trained offer-affinity asset prediction model, in accordance with some embodiments.

FIG. 14 illustrates a context-specific interface generated by the NBA offer interface architecture, in accordance with some embodiments.

### DETAILED DESCRIPTION

This description of the exemplary embodiments is intended to be read in connection with the accompanying drawings, which are to be considered part of the entire written description. The drawing figures are not necessarily to scale and certain features of the invention may be shown exaggerated in scale or in somewhat schematic form in the interest of clarity and conciseness. Terms concerning data connections, coupling and the like, such as “connected” and “interconnected,” and/or “in signal communication with” refer to a relationship wherein systems or elements are electrically and/or wirelessly connected to one another either directly or indirectly through intervening systems, as well as both moveable or rigid attachments or relationships, unless expressly described otherwise. The term “operatively coupled” is such a coupling or connection that allows the pertinent structures to operate as intended by virtue of that relationship.

In the following, various embodiments are described with respect to the claimed systems as well as with respect to the claimed methods. Features, advantages, or alternative embodiments herein can be assigned to the other claimed objects and vice versa. In other words, claims for the systems can be improved with features described or claimed in the context of the methods. In this case, the functional features of the method are embodied by objective units of the systems.

Furthermore, in the following, various embodiments are described with respect to methods and systems for predicting a set of next best eligible (or top X eligible) assets relevant to a user. Assets can be considered “next best” or “top X” if such assets are more likely than other assets to result in a selected response, such as, for example, engagement with the assets. In some embodiments, the disclosed systems and methods, the next best eligible assets are those assets having an optimized click rate with respect to other available assets.

In some embodiments, systems, and methods for predicting a set of next best eligible assets includes a trained asset prediction model configured to generate the set of next best eligible assets.

In general, a trained function mimics cognitive functions that humans associate with other human minds. In particular, by training based on training data the trained function is able to adapt to new circumstances and to detect and extrapolate patterns.

In general, parameters of a trained function can be adapted by means of training. In particular, a combination of supervised training, semi-supervised training, unsupervised training, reinforcement learning and/or active learning can be used. Furthermore, representation learning (an alternative term is “feature learning”) can be used. In particular, the parameters of the trained functions can be adapted iteratively by several steps of training.

In particular, a trained function can comprise a neural network, a support vector machine, a decision tree and/or a Bayesian network, and/or the trained function can be based on k-means clustering, Qlearning, genetic algorithms and/or association rules. In particular, a neural network can be a deep neural network, a convolutional neural network, or a convolutional deep neural network. Furthermore, a neural network can be an adversarial network, a deep adversarial network and/or a generative adversarial network.

In various embodiments, a neural network which is trained (e.g., configured or adapted) to generate next best action predictions, is disclosed. A neural network trained to generate next best action predictions may be referred to as a trained prediction model and/or a trained action prediction model. The trained prediction model can be configured to generate a set of assets (or actions) that have the highest likelihood of interaction. As discussed herein, the set of assets can be selected based on one or more features of the selected assets and/or a profile associated with a system interacting with a user interface.

In various embodiments, the set of assets selected by the trained prediction model can be provided to an interface generation module configured to generate a user interface. The user interface can include one or more positions configured to receive selected assets and/or can be dynamically generated to include one or more selected assets. The user interface can include both static assets and assets selected by the trained prediction model. The number of assets selected by the trained prediction model can be predetermined, e.g., the user interface can include a predetermined number of containers configured to receive selected assets, and/or can be selected dynamically, e.g., based on the number of assets selected by the trained prediction model.

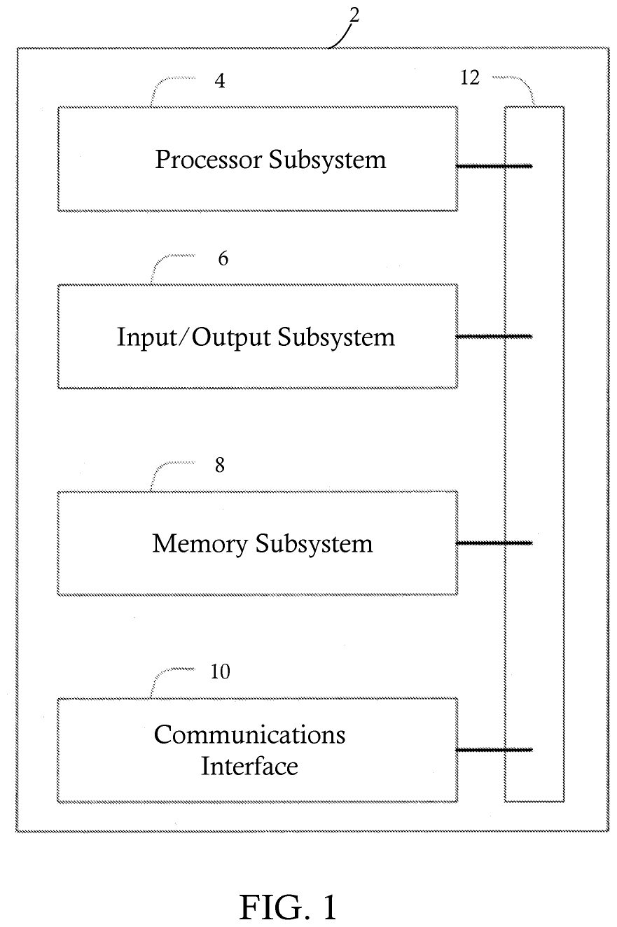

FIG. 1 illustrates a computer system configured to implement one or more processes, in accordance with some embodiments. The system 2 is a representative device and can include a processor subsystem 4, an input/output subsystem 6, a memory subsystem 8, a communications interface 10, and a system bus 12. In some embodiments, one or more than one of the system 2 components can be combined or omitted such as, for example, not including an input/output subsystem 6. In some embodiments, the system 2 can include other components not combined or comprised in those shown in FIG. 1. For example, the system 2 can also include, for example, a power subsystem. In other embodiments, the system 2 can include several instances of the components shown in FIG. 1. For example, the system 2 can include multiple memory subsystems 8. For the sake of conciseness and clarity, and not limitation, one of each of the components is shown in FIG. 1.

The processor subsystem 4 can include any processing circuitry operative to control the operations and performance of the system 2. In various aspects, the processor subsystem 4 can be implemented as a general purpose processor, a chip multiprocessor (CMP), a dedicated processor, an embedded processor, a digital signal processor (DSP), a network processor, an input/output (I/O) processor, a media access control (MAC) processor, a radio baseband processor, a co-processor, a microprocessor such as a complex instruction set computer (CISC) microprocessor, a reduced instruction set computing (RISC) microprocessor, and/or a very long instruction word (VLIW) microprocessor, or other processing device. The processor subsystem 4 also can be implemented by a controller, a microcontroller, an application specific integrated circuit (ASIC), a field programmable gate array (FPGA), a programmable logic device (PLD), and so forth.

In various aspects, the processor subsystem 4 can be arranged to run an operating system (OS) and various applications. Examples of an OS comprise, for example, operating systems generally known under the trade name of Apple OS, Microsoft Windows OS, Android OS, Linux OS, and any other proprietary or open-source OS. Examples of applications comprise, for example, network applications, local applications, data input/output applications, user interaction applications, etc.

In some embodiments, the system 2 can include a system bus 12 that couples various system components including the processor subsystem 4, the input/output subsystem 6, and the memory subsystem 8. The system bus 12 can be any of several types of bus structure(s) including a memory bus or memory controller, a peripheral bus or external bus, and/or a local bus using any variety of available bus architectures including, but not limited to, 9-bit bus, Industrial Standard Architecture (ISA), Micro-Channel Architecture (MSA), Extended ISA (EISA), Intelligent Drive Electronics (IDE), VESA Local Bus (VLB), Peripheral Component Interconnect Card International Association Bus (PCMCIA), Small Computers Interface (SCSI) or other proprietary bus, or any custom bus suitable for computing device applications.

In some embodiments, the input/output subsystem 6 can include any suitable mechanism or component to enable a user to provide input to system 2 and the system 2 to provide output to the user. For example, the input/output subsystem 6 can include any suitable input mechanism, including but not limited to, a button, keypad, keyboard, click wheel, touch screen, motion sensor, microphone, camera, etc.

In some embodiments, the input/output subsystem 6 can include a visual peripheral output device for providing a display visible to the user. For example, the visual peripheral output device can include a screen such as, for example, a Liquid Crystal Display (LCD) screen. As another example, the visual peripheral output device can include a movable display or projecting system for providing a display of content on a surface remote from the system 2. In some embodiments, the visual peripheral output device can include a coder/decoder, also known as Codecs, to convert digital media data into analog signals. For example, the visual peripheral output device can include video Codecs, audio Codecs, or any other suitable type of Codec.

The visual peripheral output device can include display drivers, circuitry for driving display drivers, or both. The visual peripheral output device can be operative to display content under the direction of the processor subsystem 4. For example, the visual peripheral output device may be able to play media playback information, application screens for application implemented on the system 2, information regarding ongoing communications operations, information regarding incoming communications requests, or device operation screens, to name only a few.

In some embodiments, the communications interface 10 can include any suitable hardware, software, or combination of hardware and software that is capable of coupling the system 2 to one or more networks and/or additional devices. The communications interface 10 can be arranged to operate with any suitable technique for controlling information signals using a desired set of communications protocols, services, or operating procedures. The communications interface 10 can include the appropriate physical connectors to connect with a corresponding communications medium, whether wired or wireless.

Vehicles of communication comprise a network. In various aspects, the network can include local area networks (LAN) as well as wide area networks (WAN) including without limitation Internet, wired channels, wireless channels, communication devices including telephones, computers, wire, radio, optical or other electromagnetic channels, and combinations thereof, including other devices and/or components capable of/associated with communicating data. For example, the communication environments comprise in-body communications, various devices, and various modes of communications such as wireless communications, wired communications, and combinations of the same.

Wireless communication modes comprise any mode of communication between points (e.g., nodes) that utilize, at least in part, wireless technology including various protocols and combinations of protocols associated with wireless transmission, data, and devices. The points comprise, for example, wireless devices such as wireless headsets, audio and multimedia devices and equipment, such as audio players and multimedia players, telephones, including mobile telephones and cordless telephones, and computers and computer-related devices and components, such as printers, network-connected machinery, and/or any other suitable device or third-party device.

Wired communication modes comprise any mode of communication between points that utilize wired technology including various protocols and combinations of protocols associated with wired transmission, data, and devices. The points comprise, for example, devices such as audio and multimedia devices and equipment, such as audio players and multimedia players, telephones, including mobile telephones and cordless telephones, and computers and computer-related devices and components, such as printers, network-connected machinery, and/or any other suitable device or third-party device. In various implementations, the wired communication modules can communicate in accordance with a number of wired protocols. Examples of wired protocols can include Universal Serial Bus (USB) communication, RS-232, RS-422, RS-423, RS-485 serial protocols, FireWire, Ethernet, Fibre Channel, MIDI, ATA, Serial ATA, PCI Express, T-1 (and variants), Industry Standard Architecture (ISA) parallel communication, Small Computer System Interface (SCSI) communication, or Peripheral Component Interconnect (PCI) communication, to name only a few examples.

Accordingly, in various aspects, the communications interface 10 can include one or more interfaces such as, for example, a wireless communications interface, a wired communications interface, a network interface, a transmit interface, a receive interface, a media interface, a system interface, a component interface, a switching interface, a chip interface, a controller, and so forth. When implemented by a wireless device or within wireless system, for example, the communications interface 10 can include a wireless interface comprising one or more antennas, transmitters, receivers, transceivers, amplifiers, filters, control logic, and so forth.

In various aspects, the communications interface 10 can provide data communications functionality in accordance with a number of protocols. Examples of protocols can include various wireless local area network (WLAN) protocols, including the Institute of Electrical and Electronics Engineers (IEEE) 802.xx series of protocols, such as IEEE 802.11a/b/g/n/ac/ax/be, IEEE 802.16, IEEE 802.20, and so forth. Other examples of wireless protocols can include various wireless wide area network (WWAN) protocols, such as GSM cellular radiotelephone system protocols with GPRS, CDMA cellular radiotelephone communication systems with 1×RTT, EDGE systems, EV-DO systems, EV-DV systems, HSDPA systems, the Wi-Fi series of protocols including Wi-Fi Legacy, Wi-Fi 1/2/3/4/5/6/6E, and so forth. Further examples of wireless protocols can include wireless personal area network (PAN) protocols, such as an Infrared protocol, a protocol from the Bluetooth Special Interest Group (SIG) series of protocols (e.g., Bluetooth Specification versions 5.0, 6, 7, legacy Bluetooth protocols, etc.) as well as one or more Bluetooth Profiles, and so forth. Yet another example of wireless protocols can include near-field communication techniques and protocols, such as electro-magnetic induction (EMI) techniques. An example of EMI techniques can include passive or active radio-frequency identification (RFID) protocols and devices. Other suitable protocols can include Ultra-Wide Band (UWB), Digital Office (DO), Digital Home, Trusted Platform Module (TPM), ZigBee, and so forth.

In some embodiments, at least one non-transitory computer-readable storage medium is provided having computer-executable instructions embodied thereon, wherein, when executed by at least one processor, the computer-executable instructions cause the at least one processor to perform embodiments of the methods described herein. This computer-readable storage medium can be embodied in memory subsystem 8.

In some embodiments, the memory subsystem 8 can include any machine-readable or computer-readable media capable of storing data, including both volatile/non-volatile memory and removable/non-removable memory. The memory subsystem 8 can include at least one non-volatile memory unit. The non-volatile memory unit is capable of storing one or more software programs. The software programs can contain, for example, applications, user data, device data, and/or configuration data, or combinations therefore, to name only a few. The software programs can contain instructions executable by the various components of the system 2.

In various aspects, the memory subsystem 8 can include any machine-readable or computer-readable media capable of storing data, including both volatile/non-volatile memory and removable/non-removable memory. For example, memory can include read-only memory (ROM), random-access memory (RAM), dynamic RAM (DRAM), Double-Data-Rate DRAM (DDR-RAM), synchronous DRAM (SDRAM), static RAM (SRAM), programmable ROM (PROM), erasable programmable ROM (EPROM), electrically erasable programmable ROM (EEPROM), flash memory (e.g., NOR or NAND flash memory), content addressable memory (CAM), polymer memory (e.g., ferroelectric polymer memory), phase-change memory (e.g., ovonic memory), ferroelectric memory, silicon-oxide-nitride-oxide-silicon (SONOS) memory, disk memory (e.g., floppy disk, hard drive, optical disk, magnetic disk), or card (e.g., magnetic card, optical card), or any other type of media suitable for storing information.

In one embodiment, the memory subsystem 8 can contain an instruction set, in the form of a file for executing various methods, such as methods for selecting a next best action and/or generating a user interface, as described herein. The instruction set can be stored in any acceptable form of machine-readable instructions, including source code or various appropriate programming languages. Some examples of programming languages that can be used to store the instruction set comprise, but are not limited to: Java, C, C++, C#, Python, Objective-C, Visual Basic, or .NET programming. In some embodiments a compiler or interpreter is comprised to convert the instruction set into machine executable code for execution by the processor subsystem 4.

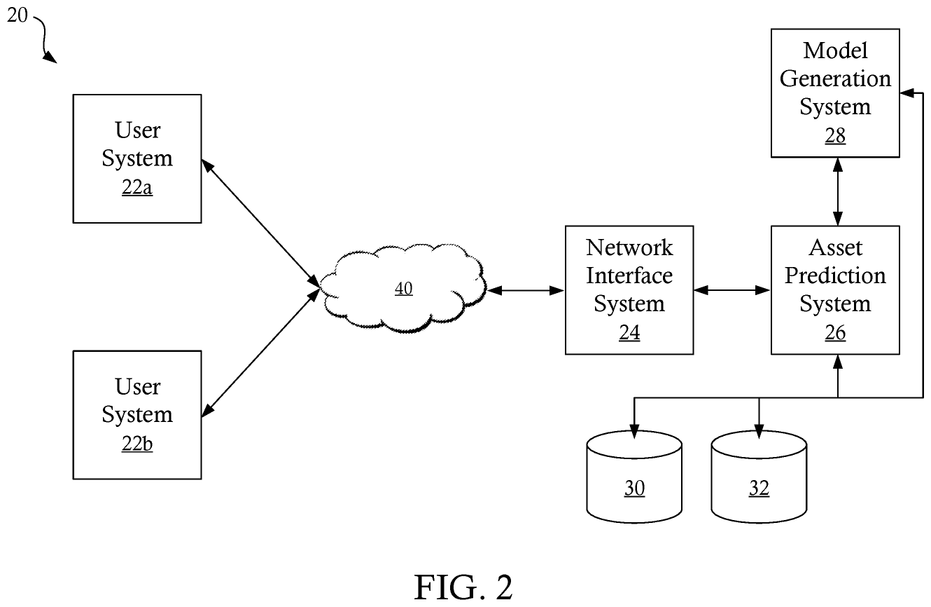

FIG. 2 illustrates a network environment 20 configured to provide an interface having one or more assets generated by a next best asset prediction system, in accordance with some embodiments. The network environment 20 includes a plurality of systems configured to communicate over one or more network channels, illustrated as network cloud 40. For example, in various embodiments, the network environment 20 can include, but is not limited to, one or more user systems 22a-22b in signal communication with a frontend system 24. The frontend system 24 can be configured to provide a customized interface, including one or more assets selected by an asset prediction model, to each of the one or more user systems 22a-22b.

The customized interface can include any suitable interface. For example, in some embodiments, the customized interface can include an e-commerce interface, a service interface, an intranet interface, and/or any other suitable user interface. In some embodiments, the customized interface includes a webpage, web portal, intranet page, and/or other interactive page generated by the frontend system 24. In some embodiments, the customized interface includes one or more assets selected by an asset prediction model implemented by one or more systems, such as an asset prediction system 26.

In some embodiments, the asset prediction system 26 is configured to implement an asset prediction model. As discussed in greater detail below, the asset prediction model is a trained machine learning model configured to generate a set of assets having a highest-likely engagement for a user system 22a, 22b interacting with the frontend system 24. The asset prediction model can be configured to select a set of assets from a set of predefined assets and/or customizable assets. The set of predefined and/or customizable assets can be stored in a database, such as database 30. In some embodiments, the asset prediction model is configured to provide a set of contextual assets based on, for example, a context of the user interface. In some embodiments, the asset prediction model is configured to select a set of assets based on user-preference data for a user associated with a user system 22a, 22b. The user-preference data can be stored in a database, such as database

The inclusion of one or more next best assets identified by the asset prediction system 26 in a user interface is configured to increase interaction with the interface. In some embodiments, the set of predicted assets is configured to provide user-relevant actions or assets on interface pages without the user having to expressly select pages statically containing those elements.

For example, a user that recently placed an order can have a higher interaction rate with assets related to order tracking and delivery, such as scheduling assets, driver tipping assets, cancellation assets, order status assets, etc. A user who is unaware of the location of these assets within a network environment can have a lower interaction rate. In some embodiments, the asset prediction system 26 selects one or more order tracking and delivery assets for presentation on a requested interface that otherwise would not have included order tracking and delivery assets.

As another example, a user can be a good candidate for enrollment in a loyalty program and/or likely to enroll in a financial incentive program. However, a user may not actively seek out interface pages containing these programs, either due to lack of knowledge (e.g., not being aware such programs exist) or lack or direction (e.g., not knowing exactly where to go to get the programs). In some embodiments, the asset prediction system 26 selects one or more program assets for presentation on a requested interface that otherwise would not have included program assets.

In some embodiments, predicted assets can be selected and presented based on current activity or interactions with the interface. For example, in some embodiments, a request for an interface can include a request for category of products available through an e-commerce interface, such as grocery products. When the e-commerce interface is generated, the asset prediction system 26 can identify products that are likely to be selected through the interface and provide a predicted asset for adding each of the most likely products to a cart for purchase. Each product can be presented in a standalone asset, e.g., an add to cart asset for each identified product, and/or a grouping of products can be presented as a single asset, e.g., to add a group of products to a cart.

In some embodiments, one or more selected assets are configured to transition the interface to a new interface page and/or present a different interface element. For example, in some embodiments, a predicted asset is configured to transition an interface to a page for completing an action presented in the asset. Such pages can include, but are not limited to, product pages, program enrollment pages, order specific pages, etc. In some embodiments, interaction with a selected next best asset generates a pop-up or other additional interface element to allow completion of an activity related to the selected asset.

As discussed in greater detail below, the set of predicted assets are configured to increase interaction with the interface, allows a user to easily identify assets of interest to solve one or more needs or problems, and reduces time to complete activities using the interface by presenting next steps for current processes in prominent locations on the interface. In some embodiments, interaction with a predicted asset causes an interface modification based on the predicted asset and/or interaction with the predicted asset.

In some embodiments, the next best assets are presented as a rotating container or carousel of assets. For example, a first selected asset and a second selected asset can be presented on an interface by the frontend system 24. If the frontend system 24 receives an indication that the first presented asset is not relevant, for example, if the frontend system 24 receives a request to dismiss or close the first selected asset, the first selected asset can be removed from the interface and a third selected asset can be presented in place of the first selected asset. Additionally, in some embodiments, the frontend system 24 can store an indication of the dismissal of the first selected asset as a feature of the first selected asset such that the first selected asset is less likely to be presented in a similar context.

In some embodiments, the network environment 20 includes a model training system 28 configured to generate one or more trained asset prediction models. The model training system 28 can be configured to implement an iterative training process, as discussed in greater detail below, to generate the trained asset prediction model(s). In some embodiments, the model training system 28 is configured to generate context-specific asset prediction models. For example, in some embodiments, the model training system 28 is configured to generate context-specific asset prediction models for specific portions or pages of an interface generated by the frontend system 24. A context-specific asset prediction model can be generated by providing a context-specific training data set to a training process. Context-specific training data can include, but is not limited to, context-specific user features and/or context-specific asset features. The one or more generated asset prediction models can be provided to an asset prediction system 26 for implementation, e.g., prediction of next best assets as part of an interface generation process.

In some embodiments, the model training system 28 is configured to obtain training data sets, such as user-preference features, asset features, and/or user-asset features, from a feature database 32. Although a single feature database 32 is illustrated, it will be appreciated that multiple databases can be implemented. For example, a user-preference feature database, an asset feature database, and a user-asset feature database can each be implemented to store respective features. In some embodiments, the model training system 28 is configured to receive one or more identifiers, such as a user identifier or an asset identifier, as part of training data set. Each of the identifiers can be used to retrieve a set of features associated with the user identifier or the asset identifier.

In various embodiments, the system or components thereof can comprise or include various modules or engines, each of which is constructed, programmed, configured, or otherwise adapted, to autonomously carry out a function or set of functions. A module/engine can include a component or arrangement of components implemented using hardware, such as by an application specific integrated circuit (ASIC) or field-programmable gate array (FPGA), for example, or as a combination of hardware and software, such as by a microprocessor system and a set of program instructions that adapt the module/engine to implement the particular functionality, which (while being executed) transform the microprocessor system into a special-purpose device. A module/engine can also be implemented as a combination of the two, with certain functions facilitated by hardware alone, and other functions facilitated by a combination of hardware and software. In certain implementations, at least a portion, and in some cases, all, of a module/engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each module/engine can be realized in a variety of physically realizable configurations, and should generally not be limited to any particular implementation exemplified herein, unless such limitations are expressly called out. In addition, a module/engine can itself be composed of more than one sub-modules or sub-engines, each of which can be regarded as a module/engine in its own right. Moreover, in the embodiments described herein, each of the various modules/engines corresponds to a defined autonomous functionality; however, it should be understood that in other contemplated embodiments, each functionality can be distributed to more than one module/engine. Likewise, in other contemplated embodiments, multiple defined functionalities may be implemented by a single module/engine that performs those multiple functions, possibly alongside other functions, or distributed differently among a set of modules/engines than specifically illustrated in the examples herein.

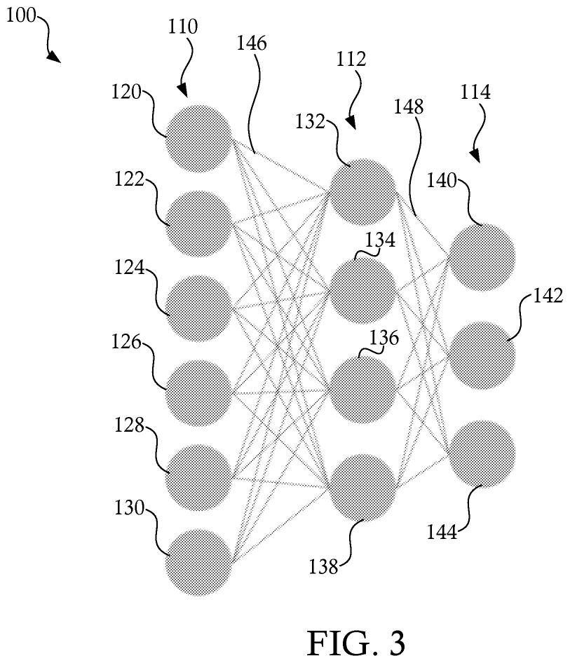

FIG. 3 illustrates an artificial neural network 100, in accordance with some embodiments. Alternative terms for “artificial neural network” are “neural network,” “artificial neural net,” “neural net,” or “trained function.” The neural network 100 comprises nodes 120-144 and edges 146-148, wherein each edge 146-148 is a directed connection from a first node 120-138 to a second node 132-144. In general, the first node 120-138 and the second node 132-144 are different nodes, although it is also possible that the first node 120-138 and the second node 132-144 are identical. For example, in FIG. 3 the edge 146 is a directed connection from the node 120 to the node 132, and the edge 148 is a directed connection from the node 132 to the node 140. An edge 146-148 from a first node 120-138 to a second node 132-144 is also denoted as “ingoing edge” for the second node 132-144 and as “outgoing edge” for the first node 120-138.

The nodes 120-144 of the neural network 100 can be arranged in layers 110-114, wherein the layers can comprise an intrinsic order introduced by the edges 146-148 between the nodes 120-144. In particular, edges 146-148 can exist only between neighboring layers of nodes. In the illustrated embodiment, there is an input layer 110 comprising only nodes 120-130 without an incoming edge, an output layer 114 comprising only nodes 140-144 without outgoing edges, and a hidden layer 112 in-between the input layer 110 and the output layer 114. In general, the number of hidden layer 112 can be chosen arbitrarily and/or through training. The number of nodes 120-130 within the input layer 110 usually relates to the number of input values of the neural network, and the number of nodes 140-144 within the output layer 114 usually relates to the number of output values of the neural network.

In particular, a (real) number can be assigned as a value to every node 120-144 of the neural network 100. Here, xᵢ⁽ⁿ⁾ denotes the value of the i-th node 120-144 of the n-th layer 110-114. The values of the nodes 120-130 of the input layer 110 are equivalent to the input values of the neural network 100, the values of the nodes 140-144 of the output layer 114 are equivalent to the output value of the neural network 100. Furthermore, each edge 146-148 can comprise a weight being a real number, in particular, the weight is a real number within the interval [−1, 1] or within the interval [0, 1]. Here, w_{i,j}^{(m,n)} denotes the weight of the edge between the i-th node 120-138 of the m-th layer 110, 112 and the j-th node 132-144 of the n-th layer 112, 114. Furthermore, the abbreviation w_{i,j}⁽ⁿ⁾ is defined for the weight w_{i,j}^{(n,n+1)}.

In particular, to calculate the output values of the neural network 100, the input values are propagated through the neural network. In particular, the values of the nodes 132-144 of the (n+1)-th layer 112, 114 can be calculated based on the values of the nodes 120-138 of the n-th layer 110, 112 by

$${x}_{j}^{( n + 1 )} = f ( {\sum }_{i} {x}_{i}^{( n )} \cdot {w}_{i , j}^{( n )} )$$

Herein, the function f is a transfer function (another term is “activation function”). Known transfer functions are step functions, sigmoid function (e.g., the logistic function, the generalized logistic function, the hyperbolic tangent, the Arctangent function, the error function, the smooth step function) or rectifier functions. The transfer function is mainly used for normalization purposes.

In particular, the values are propagated layer-wise through the neural network, wherein values of the input layer 110 are given by the input of the neural network 100, wherein values of the hidden layer(s) 112 can be calculated based on the values of the input layer 110 of the neural network and/or based on the values of a prior hidden layer, etc.

In order to set the values w_{i,j}^{(m,n)} for the edges, the neural network 100 has to be trained using training data. In particular, training data comprises training input data and training output data. For a training step, the neural network 100 is applied to the training input data to generate calculated output data. In particular, the training data and the calculated output data comprise a number of values, said number being equal with the number of nodes of the output layer.

In particular, a comparison between the calculated output data and the training data is used to recursively adapt the weights within the neural network 100 (backpropagation algorithm). In particular, the weights are changed according to

$${w}_{i , j}^{′ ( n )} = {w}_{i , j}^{( n )} - γ \cdot {δ}_{j}^{( n )} \cdot {x}_{i}^{( n )}$$

wherein γ is a learning rate, and the numbers δⱼ⁽ⁿ⁾ can be recursively calculated as

$${δ}_{j}^{( n )} = ( {\sum }_{k} {δ}_{k}^{( n + 1 )} \cdot {w}_{j , k}^{( n + 1 )} ) \cdot {f}^{′} ( {\sum }_{i} {x}_{i}^{( n )} \cdot {w}_{i , j}^{( n )} )$$

based on δⱼ⁽ⁿ⁺¹⁾, if the (n+1)-th layer is not the output layer, and

$${δ}_{j}^{( n )} = ( {x}_{k}^{( n + 1 )} - {t}_{j}^{( n + 1 )} ) \cdot {f}^{′} ( {\sum }_{i} {x}_{i}^{( n )} \cdot {w}_{i , j}^{( n )} )$$

if the (n+1)-th layer is the output layer 114, wherein f′ is the first derivative of the activation function, and yⱼ⁽ⁿ⁺¹⁾ is the comparison training value for the j-th node of the output layer 114.

In some embodiments, the neural network 100 is configured, or trained, to generate a set of assets having a highest-likely engagement for presentation within an interface. For example, in some embodiments, the neural network 100 is configured to receive a set of predefined and/or customizable assets and one or more user features. The neural network 100 is trained to select, or identify, the set of assets that have the highest-likely engagement. For example, in some embodiments, the neural network 100 is trained to select a set of assets having a highest-likely click rate, although it will be appreciated that any suitable engagement metric can be optimized.

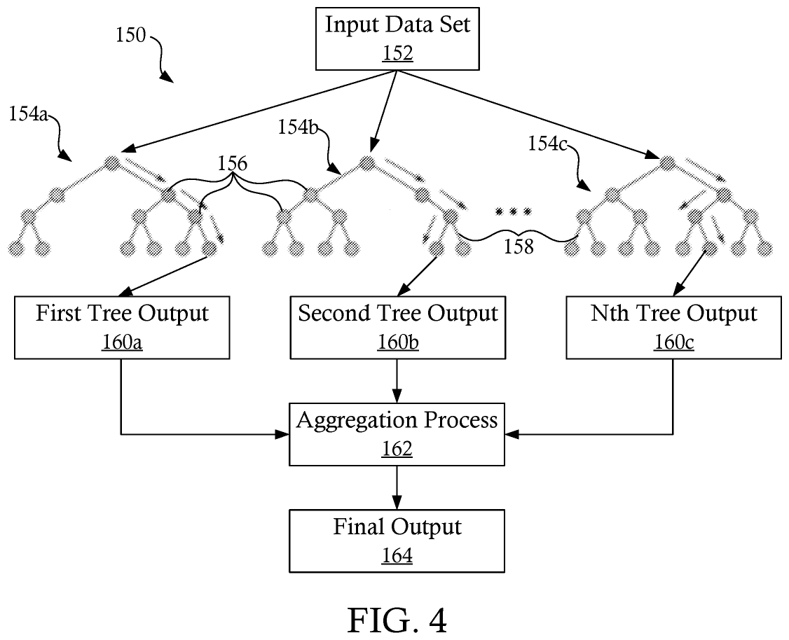

FIG. 4 illustrates a tree-based neural network 150, in accordance with some embodiments. In particular, the tree-based neural network 150 is a random forest neural network, though it will be appreciated that the discussion herein is applicable to other decision tree neural networks. The tree-based neural network 150 includes a plurality of trained decision trees 154a-154c each including a set of nodes 156 (also referred to as “leaves”) and a set of edges 158 (also referred to as “branches”).

Each of the trained decision trees 154a-154c can include a classification and/or a regression tree (CART). Classification trees include a tree model in which a target variable can take a discrete set of values, e.g., can be classified as one of a set of values. In classification trees, each leaf 156 represents class labels and each of the branches 158 represents conjunctions of features that connect the class labels. Regression trees include a tree model in which the target variable can take continuous values (e.g., a real number value).

In operation, an input data set 152 including one or more features or attributes is received. A subset of the input data set 152 is provided to each of the trained decision trees 154a-154c. The subset can include a portion of and/or all of the features or attributes included in the input data set 152. Each of the trained decision trees 154a-154c is trained to receive the subset of the input data set 152 and generate a tree output value 160a-160c, such as a classification or regression output. The individual tree output value 160a-160c is determined by traversing the trained decision trees 154a-154c to arrive at a final leaf (or node) 156.

In some embodiments, the tree-based neural network 150 applies an aggregation process 162 to combine the output of each of the trained decision trees 154a-154c into a final output 164. For example, in embodiments including classification trees, the tree-based neural network 150 can apply a majority-voting process to identify a classification selected by the majority of the trained decision trees 154a-154c. As another example, in embodiments including regression trees, the tree-based neural network 150 can apply an average, mean, and/or other mathematical process to generate a composite output of the trained decision trees. The final output 164 is provided as an output of the tree-based neural network 150.

In some embodiments, the tree-based neural network 150 is configured, or trained, to generate a set of assets having a highest-likely engagement for presentation within an interface. For example, in some embodiments, the tree-based neural network 150 is configured to receive a set of predefined and/or customizable assets and one or more user features. The tree-based neural network 150 is trained to rank the set of assets according to a highest-likely engagement. For example, in some embodiments, the tree-based neural network 150 is trained to generate an expected click rate for each asset and select a set of assets having the highest expected click rate, although it will be appreciated that any suitable engagement metric can be optimized.

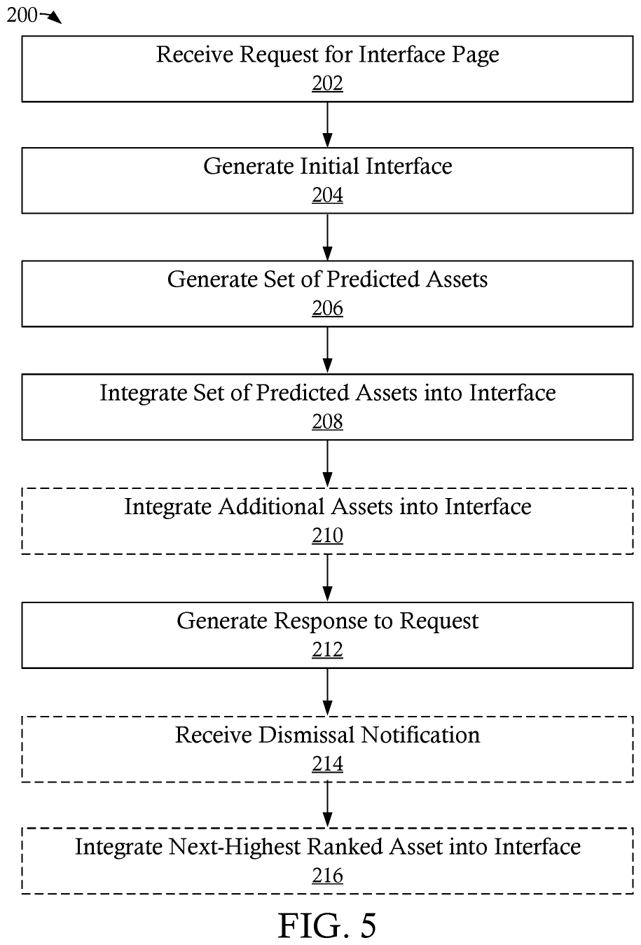

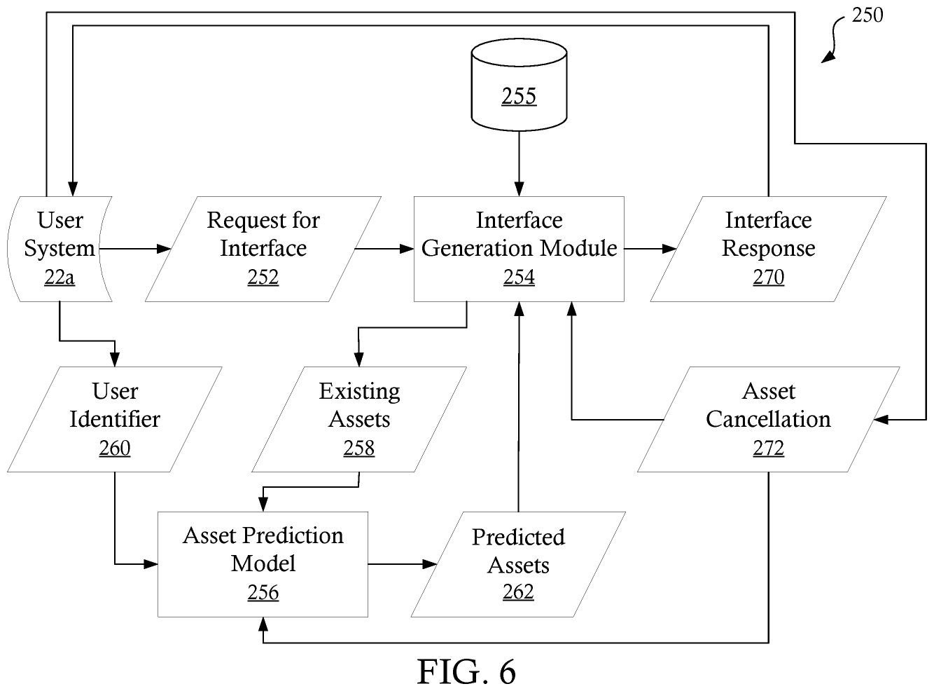

FIG. 5 is a flowchart illustrating a method 200 of generating an interface including at least one predicted asset, in accordance with some embodiments. FIG. 6 is a process flow 250 illustrating various steps of the method 200 of generating an interface of FIG. 5, in accordance with some embodiments. At step 202, a request 252 for an interface page is received by a system, such as the frontend system 24 via communications interface. The request for the interface can be received from any suitable system, such as, for example, a user system 22a, 22b. The request can include one or more data elements identifying a user or profile associated with the request. For example, in various embodiments, a request can include data elements such as cookies and/or beacons. The data elements can include features or attributes of a user associated with the request and/or can be used to retrieve features or attributes from a database.

At step 204, the system, such as the frontend system 24, implements an interface generation module 254 to generate an initial interface. The interface generation module 254 is configured to generate an initial interface, such as a webpage, for presentation to a user via the user system 22a, 22b. The interface generation module 254 is configured to obtain assets, such as predetermined static or dynamic assets, templates, default structures, etc. from an asset store 255. The asset store can include any suitable data storage structure, such as, for example, a database 30 and/or other storage structure. In some embodiments, the initial interface is generated according to a template or default interface.

In some embodiments, the interface generation module 254 is configured to implement a template or default interface for a predetermined context. For example, in some embodiments, the interface generation module 254 can be configured to implement a default page template related to page context such as a home page, account page, loyalty program page, etc. The interface generation module 254 is configured to customize (e.g., personalize) the default interface to include predicted assets selected by an asset prediction model, as discussed in greater detail below. In some embodiments, the predicted assets are asset templates that can be further customized and/or personalized for a user based on one or more customization processes.

At step 206, a set of predicted assets 262 is generated. The set of a predicted assets 262 include a set of assets having a highest likelihood of engagement for the given interface request, e.g., is a set of predicted next-best assets. For example, in some embodiments, the interface generation module 254 requests a set of predicted assets 262 from an asset prediction model 256. The asset prediction model 256 includes a trained machine learning model configured to generate a set of predicted next best assets. In some embodiments, the asset prediction model 256 is configured to identify a set of assets having a highest likelihood of interaction or engagement for the generated interface. In some embodiments, the asset prediction model 256 is configured to receive, as an input, a set of existing assets 258 and a user identifier 260 and generate, as an output, a ranked set of predicted assets 262.

In some embodiments, the asset prediction model 256 is configured to optimize likelihood of one or more predetermined measures of engagement. For example, in some embodiments, the asset prediction model 256 is configured to optimize a click rate for an asset that is selected and presented on an interface. A higher likely click rate indicates a higher likelihood that the content of the asset is relevant to a user and that a user will click-on (or otherwise interact with) the presented asset. Although embodiments are discussed herein including optimized click rate, it will be appreciated that the asset prediction model 256 can be configured to optimize any suitable measure of engagement.

The asset prediction model 256 can include any suitable machine learning classification model, such as, for example, a linear model such as a linear regression, a logistic regression, or a support vector machine (SVM), classification and regression tree models such as boosted trees, bootstrap decision trees, random forest, Gini, or chi-square, a k-nearest neighbor model, a Naive Bayes model, and/or any other suitable classification model. For example, in some embodiments, a random forest model having balanced weights, a max depth of 10, minimal samples per leaf of 10, and an n estimators value of 20 can be implemented to select a set of next best assets. Although specific embodiments are discussed herein, it will be appreciated that any suitable model having any suitable weights can be used to generate a set of next best assets.

At step 208, the set of predicted assets 262 is received from the asset prediction model 256 and integrated into an interface by the interface generation module 254. In some embodiments, the interface generation module 254 is configured to insert a predetermined number of assets from the set of predicted assets 262 into one or more locations within a generated interface. The interface generation module 254 can be configured to insert predicted assets based on a ranked order, starting within the highest-ranked (e.g., most-likely interaction) asset and inserting assets in descending order until the predetermined number of predicted assets has been inserted into the interface. For example, in some embodiments, the predetermined number of assets is three and the interface generation module 254 selects the three highest-ranked predicted assets for inclusion in the interface.

At optional step 210, the interface generation module 254 can implement an explore-exploit mechanic to provide additional assets within the generated interface. The explore-exploit mechanic can be configured to present assets within an interface that are not selected by an asset prediction model. The explore-exploit mechanic can be used to present new assets that have not yet been incorporated into the asset prediction model 256 and/or can be used to select assets when a user identifier lacks enough associated features to accurately predict next-best assets using the trained asset prediction model 256.

At step 212, a response 270 is provided to the user system 22a, 22b that initially transmitted the request 252 for the interface. The response 270 can include data representative of the generated interface and/or can include data for generating the interface on the user system 22a, 22b, as is known in the art. The response 270 includes the selected predetermined number of predicted assets for inclusion in the generated interface.

At optional step 214, a dismissal notification 272 is received from the user system 22a, 22b. A dismissal notification 272 indicates a dismissal or cancellation of a predicted asset, such as a first predicted asset, from the generated interface. A dismissal notification 272 can be generated if a user indicates that a predicted asset is not of interest and/or not relevant to the user. A dismissal notification 272 can also be generated if a time-sensitive predicted asset or context-specific predicted asset is not interacted with the predetermine time and/or context.

At optional step 216, a next-highest ranked asset that has not yet been presented in the interface is selected and provided to the user system 22a, 22b for inclusion in the interface. For example, if the set of predicted assets 262 included four assets, but the generated interface included only the first and second highest-ranked assets, the next-highest ranked asset is the third-highest ranked asset in the set of predicted assets 262. The next-highest ranked asset can be inserted into the interface to replace the dismissed asset and/or the previously presented assets that have not been dismissed can be shifted and the next-highest ranked asset can be inserted into the space previously occupied by a different predicted asset. It will be appreciated that the next-highest ranked asset can be inserted into any suitable position within the interface.

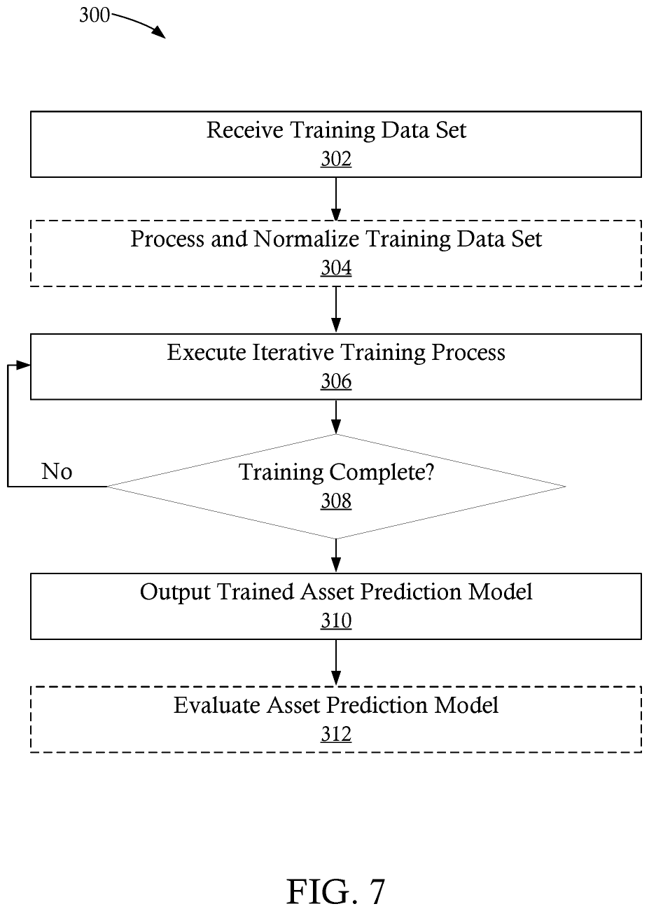

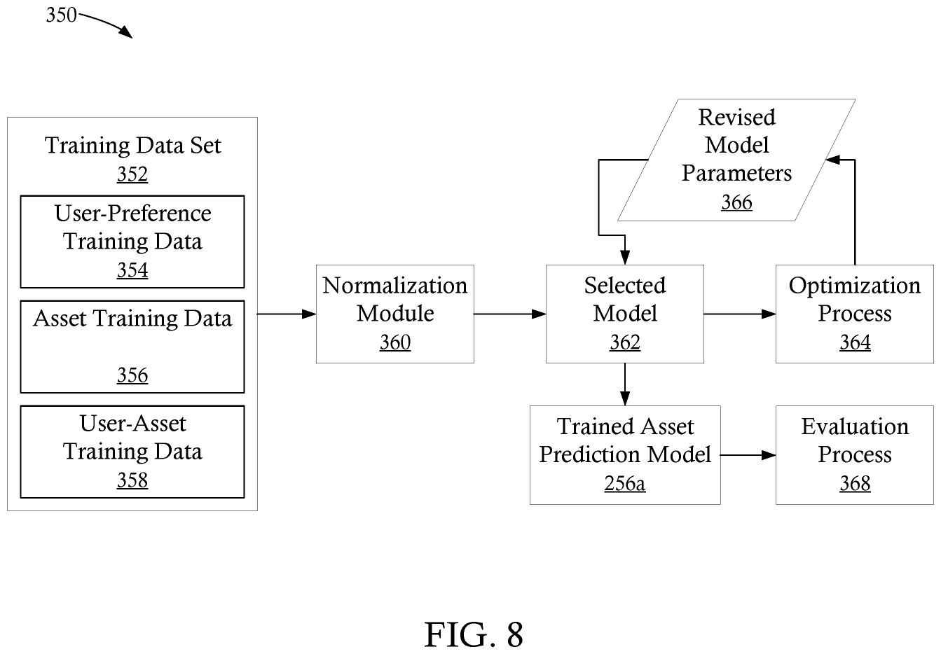

In some embodiments, an asset prediction model 256 is configured using an iterative training process based on a training data set. FIG. 7 illustrates a method 300 for generating a trained asset prediction model 256 in accordance with some embodiments. FIG. 8 is a process flow 350 illustrating various steps of the method 300 of generating a trained asset prediction model 256, in accordance with some embodiments. At step 302, a training data set 352 is received by a system, such as model training system 28. The training data set 352 can include labeled and/or unlabeled data, depending on the type of model and/or the type of training process being implemented. For example, if a supervised learning process is applied, the training data set 352 can include labeled data. As another example, if an unsupervised learning process is applied, the training data set 352 can include unlabeled data. The training data set 352 can include features configured to provide a prediction of the likelihood of interaction between a user and an asset.

In some embodiments, the training data set 352 includes user-preference training data 354. The user-preference training data 354 can include one or more user features representative of user interactions with an interface, such as user interactions with assets presented in prior interactions with an interface generated by the frontend system 24. User-preference features can include, but are not limited to, the number of transactions feature (e.g., a feature representative of a number of transactions performed by a user in a predetermined time period (e.g., per month, per week, etc.)), a user affinity feature (e.g., a feature representative of a user affinity for portions of an interface such as grocery portion or a general merchandise portion of an e-commerce interface), a context affinity feature (e.g., a feature representative of a user affinity for a specific interface context), an inter-purchase interval feature (e.g., a feature representative of time between transactions), an items viewed feature (e.g., a feature representative of a number of items viewed in a predetermined time period or frequency of items viewed in a predetermined time period), an add-to-cart feature (e.g., a feature representative of a number of items added to a cart in a predetermined time period), a fulfillment intent feature (e.g., a feature representative of a fulfillment intent (e.g., pickup, delivery, etc.) for an order), and/or other suitable user-preference features. In some embodiments, the user-preference features are representative of a user understanding that includes, for example, user-level preference features such as a brand preference feature, a price preference feature, an intent feature (e.g., purchase intent, sell intent, etc.), and/or any other suitable user-level preference features. The user-preference training data 354 can include intent-based features (e.g., features representative of a user intent when interacting with an interface), transaction-based features (e.g., features representative of transactions placed or expected to be placed by a user), eligibility-based features (e.g., features representative of user eligibility for a loyalty program), and/or any other suitable features.

In some embodiments, the training data set 352 includes asset training data 356. Asset training data 356 can include one or more asset features representative of an asset, either in isolation or as part of a generated interface. Asset features can include, but are not limited to, an asset benefit feature (e.g., a feature representative of a potential savings amount provided by an asset such as a credit card), a loyalty program affinity feature (e.g., a feature representative of a likelihood or prior enrollment in a loyalty program), a loyalty program benefits engagement feature (e.g., a feature representative of a likelihood or prior engagement with one or more loyalty program specific benefits), an initial enrollment feature (e.g., a feature representative of an initial enrollment into a loyalty program), a renewal status feature (e.g., a feature representative of the renewal status of a loyalty program enrollment), a spending feature (e.g., a feature representative of spending associated with the asset, such as purchase price, spending in a predetermined period, etc.), and/or any other suitable asset feature.

In some embodiments, the training data set 352 includes user-asset training data 358. User-asset training data 358 can include one or more features representative of user-asset interactions. User-asset features can include, but are not limited to, a number of views feature (e.g., a feature representative of the number of times a specific asset was included in an interface received by a user system 22a-22b associated with the user), a number of clicks feature (e.g., a feature representative of the number of times a specific asset was clicked-on or otherwise interacted with through a user system 22a-22b), a number of cancels features (e.g., a feature representative of the number of dismissed or cancelled assets included in an interface received by a user system 22a-22b), a loyalty program feature (e.g., a feature representative of the current state of loyalty program enrollment such as sign-up or renewal status), a tip action feature (e.g., a feature representative of prior tipping or gratuity actions for a user when interacting with certain assets, such as delivery assets), and/or any other suitable user-asset feature. In some embodiments, an asset prediction model, such as asset prediction model 256, can be updated based on interaction rates for predicted assets provided on an interface. In some embodiments, one or more features can be split into additional features. For example, a loyalty program feature can be split into an enrolled feature (e.g., a feature related to initial enrollment status in the program) and a renewal feature (e.g., a feature related to renewal enrollment status in the program).

In some embodiments, the user-asset training data 358 includes at least partially labeled training data such that the training data set 352 consists of input training data including the user-preference training data 354 and the asset training data 356 and target, or output, training data including the user-asset training data 358. The user-asset training data 358 can include data related to interactions between users represented in the user-preference training data 354 and assets represented in the asset training data 356.

In some embodiments, the training data set 352 includes identifiers for obtaining features from pre-existing feature sets stored in one or more storage locations. For example, in some embodiments, the user-preference training data 354 can include a set of user identifiers (“UIDs”). Each UID can be used to retrieve feature data relevant to and/or associated with the UID from a database containing user-preference features, such as feature database 32 discussed above. As another example, in some embodiments, the asset training data 356 can include a set of asset identifiers. Each of the asset identifiers can be used to retrieve feature data relevant to and/or associated with the asset identifiers from a database containing asset features, such as a feature database 32 discussed above.

In some embodiments, the training data set 352 includes context-specific training data configured to generate a context-specific asset prediction model. For example, in some embodiments, the training data set 352 can be limited to user-preference features, asset features, and/or user-asset features for a specific context, such as interactions with specific portions or pages of an interface. For example, in various embodiments, context-specific features can include, but are not limited to, product-category specific features (e.g., grocery specific features, general merchandise specific features, etc.), page specific features (e.g., account page features, search page specific features, etc.), and/or any other suitable context-specific features for training a context-specific asset prediction model. Context-specific asset prediction models are configured to generate a context-specific set of predicted assets.

In some embodiments, the received training data set 352 includes training data for a predetermined time period. For example, the training data set 352 can include user-preference training data 354 limited to a predetermined time period including the last n days, weeks, months, etc. where n is a positive integer (e.g., user-preference training data 354 can be limited to the last 2 or 3 months of user-preference data). As another example, in some embodiments, the user-preference training data 354 can be limited to a predetermined time period defined by a set portion of a calendar year, for example, user-preferences from the last n years for a period of time between a first month and a second month (e.g., user-preference training data 354 can be limited to the last five years for a period between August and October). Although specific embodiments are discussed herein, it will be appreciated that the predetermined time period of the training data set 352 can be selected to be any suitable time period.

In some embodiments, by limiting the time period of the training data set 352, the method 300 generates a trained asset prediction model 256a that incorporates recent user-preferences, for example, seasonal user preferences, changes in user-preferences over time, etc. As discussed in greater detail below, new models can be trained and deployed at regular intervals in order to capture changing user preferences and/or changing user-asset interactions and provide time-accurate predictions of assets for incorporation into an interface.

At optional step 304, the received training data set 352 is processed and/or normalized by a normalization module 360. For example, in some embodiments, the training data set 352 can be augmented by imputing or estimating missing values of one or more features associated with a user identifier. For example, in some embodiments, a set of user-preference features selected for training a model can include a purchase interval feature. If the user-preference training data 354 does not include a purchase interval feature for a given user identifier, the purchase interval feature can be calculated, e.g., based on the number of purchases within a predetermined time period. Similarly, if the user-preference training data 354 does not include a fulfillment intent, a fulfillment intent can be imputed to the customer identifier, for example, by looking at similarly situated customer identifiers and/or randomly selecting a fulfillment intent.

In some embodiments, processing of the received training data set 352 includes outlier detection configured to remove customer identifiers associated with features likely to skew training of an asset prediction model. For example, in some embodiments, customer identifiers associated with a large items viewed feature (e.g., a customer identifier associated with a large number of assets viewed in a predetermined time period) can be removed to prevent the large number of asset views from impacting training of the asset prediction model.

In some embodiments, processing of the received training data set 352 includes a feature selection step configured to remove features that have limited value with respect to training of the asset prediction model. For example, in some embodiments, a predetermined set of features can be selected for model training. Any features not included in the predetermined set of features can be removed from the training data set 352 prior to providing the training data set 352 to the model training process. It will be appreciated that feature selection can be omitted where the training data set 352 is initially limited to only those features relevant to training of the asset prediction model.

At step 306, an iterative training process is executed to train a selected model 362. The selected model 362 can include an untrained (e.g., base) machine learning model (e.g., a random forest model with randomly assigned initial values) and/or a partially or previously trained model (e.g., a prior version of a trained asset prediction model, a partially trained model from a prior iteration of a training process, etc.). The training process is configured to iteratively adjust parameters (e.g., hyperparameters) of the selected model 362 to minimize a cost value (e.g., an output of a cost function) for the selected model 362. In some embodiments, the cost value is related to the likelihood of interaction between a user and an asset. For example, in some embodiments, the model is configured to maximize the likelihood of interaction between a user and an asset and, conversely, minimize the likelihood of non-interaction or dismissal of the asset. In such embodiments, the cost value or cost function that is minimized can include the correctness of a prediction regarding the likelihood of interaction between a user and an asset. In some embodiments, the training process includes a hyperparameter tuning process.

The training process is an iterative process that generates set of revised model parameters 366 during each iteration. The set of revised model parameters 366 can be generated by applying an optimization process 364 to the cost function of the selected model 362. The optimization process 364 can be configured to reduce the cost value (e.g., reduce the output of the cost function) at each step by adjusting one or more parameters during each iteration of the training process. For example, when the selected model 362 includes a random forest model, the cost function can include a Gini impurity index, entropy impurity measure, a cross-entropy loss function, and/or any other suitable loss function.

After each iteration of the training process, at step 308, a determination is made whether the training process is complete. The determination at step 308 can be based on any suitable parameters. For example, in some embodiments, a training process can complete after a predetermined number of iterations. As another example, in some embodiments, a training process can complete when it is determined that the cost function of the selected model 362 has reached a minimum, such as a local minimum and/or a global minimum.

At step 310, a trained asset prediction model 256a is output and provided for use in an interface generation method, such as the method 200 discussed above with respect to FIGS. 5-6. The trained asset prediction model 256a can include a general asset prediction model and/or a context-specific asset prediction model. For example, in various embodiments, a context-specific asset prediction model can include, but is not limited to, product-category specific models (e.g., grocery specific models, general merchandise specific models, etc.), page specific models (e.g., account page models, search page specific models, etc.), and/or any other suitable context-specific features for training a context-specific asset prediction model.

At optional step 312, a trained asset prediction model 256a can be evaluated by an evaluation process 368 to determine the success rate of predicted assets generated by the trained asset prediction model 256a. The trained asset prediction model 256a can be evaluated based on any suitable metrics, such as, for example, impressions for predicted assets, interactions with predicted assets, dismissal of predicted assets, scrolling behavior for an interface including predicted assets, gross merchandise value (GMV) of products purchased through a predicted asset, accuracy of predicted assets, weighted or macro precision of predicted assets, weighted or macro recall of predicted assets, an F or F1 score of the asset prediction model, normalized discounted cumulative gain (NDCG) of the asset prediction model, mean reciprocal rank (MRR) of the predicted assets, mean average precision (MAP) score of the asset prediction model, and/or any other suitable evaluation metrics. In some embodiments, the trained asset prediction model 256a is evaluated based on a limited set of evaluation metrics. For example, a trained asset prediction model 256a can be evaluated based on weighted precision and recall, macro precision and recall, and an F-score. Although specific embodiments are discussed herein, it will be appreciated that any suitable set of evaluation metrics can be used to evaluate a trained asset prediction model 256a.

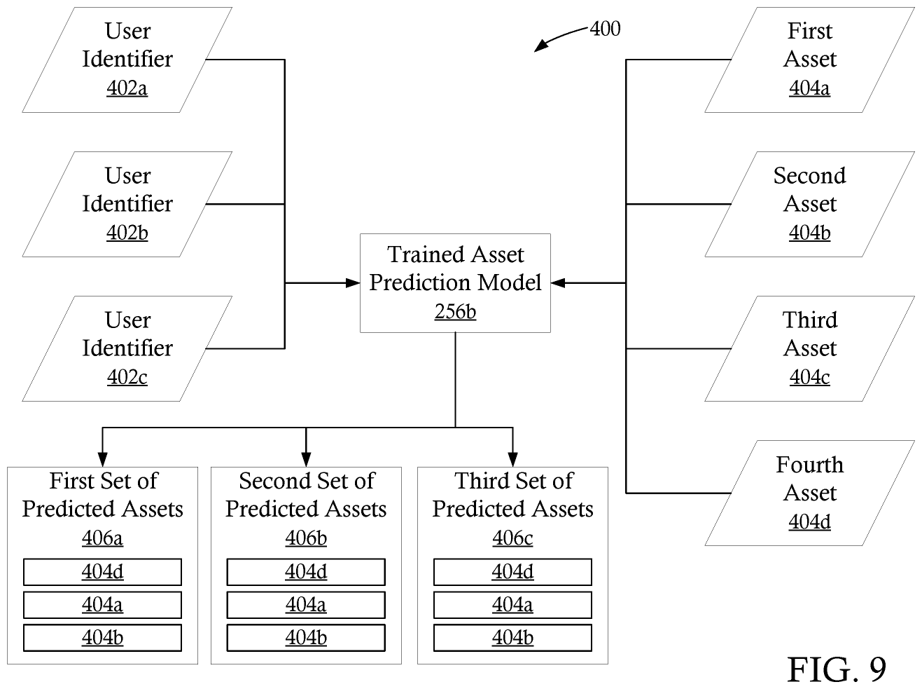

FIG. 9 illustrates a process flow 400 of a trained asset prediction model 256b configured to provide predicted next-best action/asset predictions, in accordance with some embodiments. As shown in FIG. 9, the trained asset prediction model 256b receives a set of user identifiers 402a-402c (referred to herein collectively as “user identifiers 402”) and a set of assets 404a-404d (referred to herein collectively as “assets 404”). The trained asset prediction model 256b is configured to output a set of ranked assets 406a-406c (referred to herein collectively as “sets of ranked assets 406”) for each of the user identifiers 402. Each of the sets of ranked assets 406 includes three assets selected from assets 404 arranged in ranked order corresponding to a highest likelihood of interaction for the selected asset.

For example, a first set of ranked assets 406a is generated for a first user identifier 402a, a second set of ranked assets 406b is generated for a second user identifier 402b, and a third set of ranked assets 406c is generated for a third user identifier 402c. The first set of ranked assets 406a includes the fourth asset 404d a highest ranked position, the first asset 404a at a second ranked position, and the second asset 404b at a third ranked position. Similarly, the second set of ranked assets 406b includes the first asset 404a as the highest ranked position, the third asset 404c at the second ranked position, and the second asset 404b at the third ranked position. Although specific embodiments are illustrated and discussed herein, it will be appreciated that any suitable number of assets can be ranked and provided based on an output of the trained asset prediction model 256b.

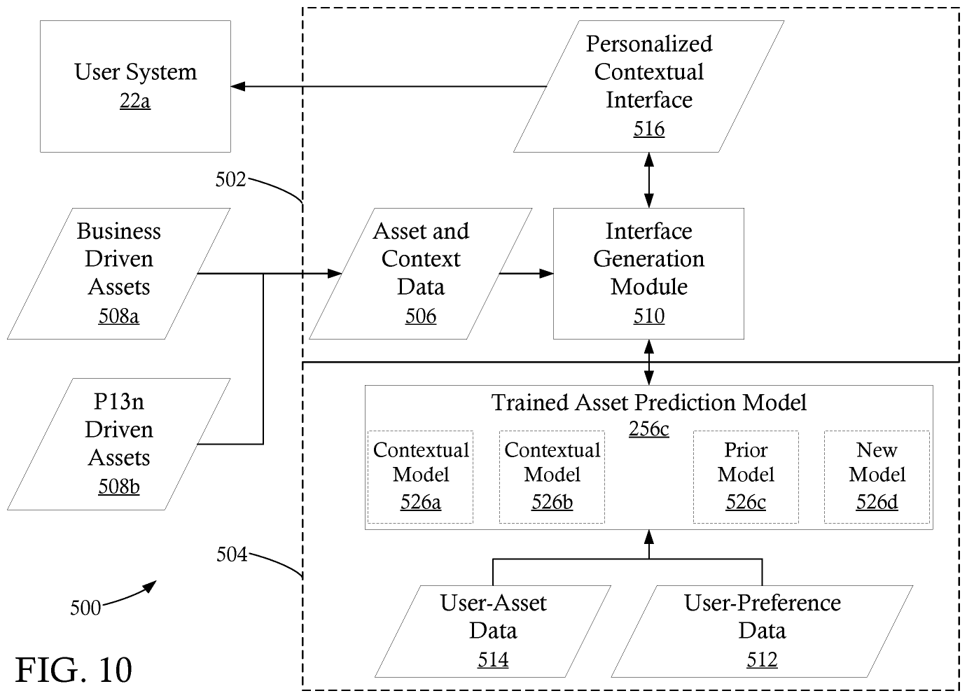

FIG. 10 illustrates a next-best action (NBA) prediction platform architecture 500, in accordance with some embodiments. The NBA prediction platform architecture 500 includes an NBA interface 502 and a data and modeling layer 504. The NBA interface 502 includes asset and context data 506 corresponding to a set of eligible assets, templates, default pages, and/or other elements that can be presented in an interface for a given user context. The set of eligible assets can include business driven assets 508a, personalization (e.g., p13n) driven assets 508b, and/or any other suitable assets (collectively referred to herein as “eligible assets 508”). In some embodiments, personalization driven assets 508b can include assets selected based on contextual clustering, objective-driven selection, and/or any other suitable criteria.

The asset and context data 506 is provided to an interface generation module 510 configured to generate an interface based on the asset and context data 506. In some embodiments, the interface generation module 510 is in signal communication with an asset prediction model 256c. As discussed above, the asset prediction model 256c can include contextually specific asset prediction models, such as a home page asset prediction model 526a, an accounts page asset prediction model 526b, or any other suitable contextually specific asset prediction model. A context specific prediction model 526a, 526b is configured to generate a context-specific set of predicted assets from the received asset and context data 506. Similarly, the asset prediction model 256c can include a preexisting asset prediction model 526c or a new (e.g., recently trained) asset prediction model 526d.

As previously discussed, the asset prediction model 256c (e.g., any of asset prediction models 526a-526d) is configured to receive a set of user-preference features 512, such as user understanding features as discussed above, a set of asset features, e.g., a set of features associated with one or more of the assets in the asset and context data, and a set of user-asset interactions 514. The asset prediction model 256c generates an output including a set of ranked assets for inclusion in an interface and provides the output to the interface generation module 510. The interface generation module 510 is configured to generate a personalized, context-specific interface 516 which is provided to a user system 22a. For example, in various embodiments, a context-specific interface 516 can be a home page interface including a first set of predicted assets selected by a home page asset prediction model 526a, an accounts page interface including a second set of predicted assets selected by an accounts page asset prediction model 526b, and/or any other suitable personalized, context-specific interface. Although specific embodiments are discussed herein, it will be appreciated that any suitable interface, including a set of predicted assets, can be generated by the interface generation module 510.

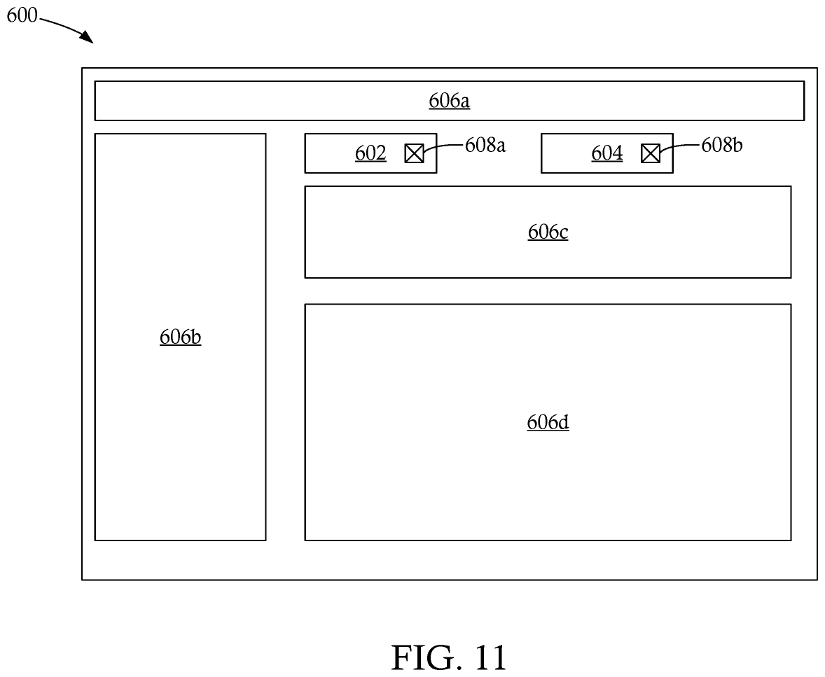

FIG. 11 illustrates an interface 600 including predicted assets 602, 604 selected by an asset prediction method, in accordance with some embodiments. The interface 600 can include any suitable interface, such as, for example, a home page of an e-commerce interface. The interface 600 includes a plurality of default or predefined elements 606a-606d, such as, for example, a title bar 606a, a sidebar 606b, a first content module 606c, and a second content module 606d. It will be appreciated that the interface 600 can include any number of predefined elements 606a-606d that provide static and/or dynamic content appropriate for the provided interface 600.

In some embodiments, the interface 600 includes a set of predicted assets 602, 604 selected by an asset prediction model, such as the asset prediction model 256 discussed above. The predicted assets 602, 604 include the top ranked assets identified by an asset prediction model, such as the asset prediction model 256, for a user associated with the interface 600. As discussed above, the predicted assets 602, 604 can be assets having a highest likelihood of engagement for a set of potential assets. The interface 600 provides the predicted assets 602, 604 in a prominent location such that the assets are readily visible and easily accessible within the interface. The predicted assets 602, 604 can be configured to generate a pop-up or other content in the current interface 600, transition a user device to a new interface, and/or perform one or more additional functions associated with the interface 600.

In some embodiments, each of the predicted assets 602, 604 includes a dismissal element 608a, 608b (collectively referred to herein as “dismissal elements 608”). The dismissal elements 608 are configured to allow a user to indicate that a predicted asset 602, 604 is not relevant or of interest to the user. When a predicted asset 602, 604 is dismissed, the dismissal action can be stored as a feature of the associated predicted asset 602, 604 and used to provide more accurate predictions in future interfaces. For example, in some embodiments, an asset prediction model can be trained (or re-trained) using a training data set including the asset dismissal information and/or an asset prediction model can be configured to receive asset dismissal information as an input asset feature to the model.

The disclosed systems and methods for next-best asset prediction allows incorporation of different assets into different use cases without altering the underlying framework configured to generate the interfaces. For example, a uniform interface can be configured to support all interface use cases with the uniform interface being modified using context-specific asset prediction models to generate context-specific assets for inclusion into the interface. In some embodiments, the disclosed next-best asset prediction methods allow temporal boosting and/or suppression of assets, based on user identifier and/or asset features, to provide only those assets that are most relevant at the current point in time. As disclosed above, an asset prediction model can be configured to incorporate user feedback, for example, in the form of dismissed assets, to continuously refine the accuracy of predicted assets.

The disclosed systems and methods of next-best action prediction disclosed herein are configured to identify complex relationships between various assets and users at a given time, e.g., a given a context or within a predetermined time period. The predicted assets, e.g., the predicted next-best actions, are the most relevant assets for a user at the current period in time.

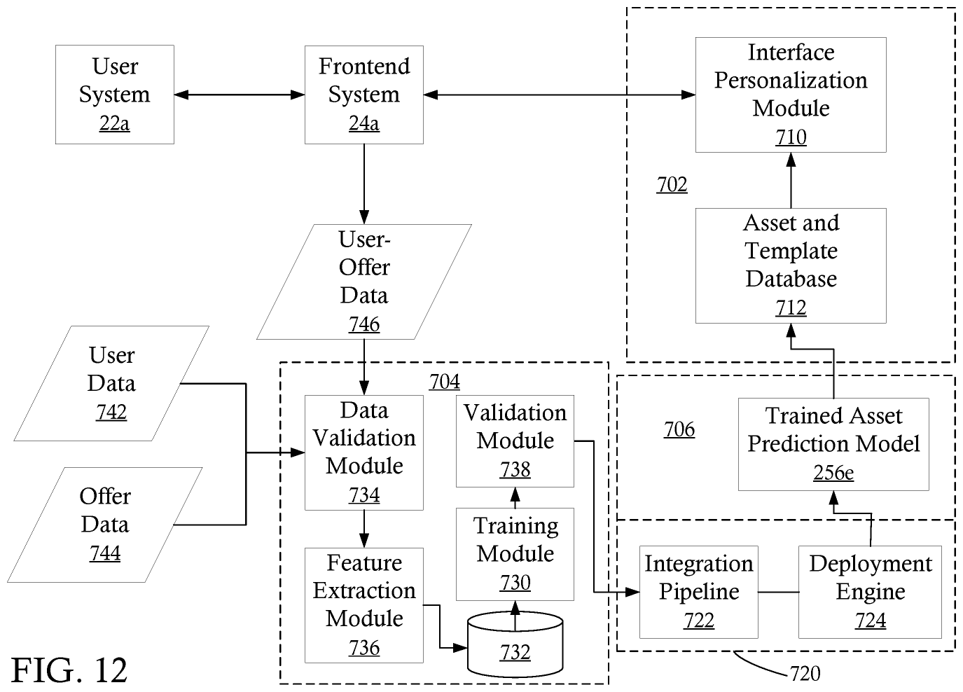

In one example embodiment, the method for generating an interface 200 discussed above can be configured to generate an accounts page specific interface having one or more user-specific credit card offer assets presented within the interface. FIG. 12 illustrates an NBA offer interface architecture 700, in accordance with some embodiments. The NBA offer interface architecture 700 is similar to the NBA prediction platform architecture 500 discussed above, and similar description is not repeated herein.

The NBA offer interface architecture 700 includes a serving layer 702, a model development layer 704, and a prediction model layer 706. A frontend client 24 is configured to receive an interface request from a user system 22a. The frontend system 24 is in signal communication with a serving layer 702 configured to generate an interface in response to the interface request form the user system 22a.

The serving layer 702 includes an interface personalization (p13n) module 710 configured to receive a request for an interface and a user identifier associated with the user system 22a and generate a personalized, context-specific interface. In the current example, the request for an interface can include a request for an interface related to a user payment account, such as an accounts page or a checkout page of an ecommerce interface. Although specific embodiments are discussed herein, it will be appreciated that the disclosed NBA credit interface architecture 700 can be generalized to any suitable context-specific interface.

The interface personalization module 710 is configured to receive a set of interface elements and/or assets from a database 712. The database 712 can include any suitable database and/or other storage structure, such as a distribution database. The database 712 includes default, or template, elements for generation of an interface. For example, database 712 can include template pages for a generalized interface (e.g., ecommerce interface) and/or context-specific template pages for specific contexts within the generalized interface (e.g., accounts page, home page, cart view page, etc.). The database 712 additionally includes a set of user-specific offer assets that are provided as personalized, predicted assets within a generated interface.

The user-specific offer assets include a set of ranked, or predicted, offer assets relevant to a specific context of the generated interface. For example, in some embodiments, the generated interface includes an accounts page or other user payment account page and the user-specific offer assets can include credit card offers for credit cards and/or credit card programs that are relevant to a user related to the user system 22a. After generating the personalized, context-specific interface, the personalization module 710 provides the generated interface to the frontend system 24 for transmission to the user system 22a.

In some embodiments, a set of ranked offer assets are generated by an asset prediction model 256e within the prediction model layer 706. The asset prediction model 256e is a context-specific asset prediction model configured to generate a predicted, or ranked, set of offer assets for presentation within a generated user interface for a specific user system 22a. The asset prediction model 256e is similar to the asset prediction models 256-256d discussed above, but is trained on a training data set limited to offer assets, customer-preference data related to offer assets, and customer-asset interaction data for offer assets.

In some embodiments, the asset prediction model 256e is deployed by a model deployment module 720 that includes a continuous integration pipeline 722 and a deployment engine 724. The continuous integration pipeline 722 is configured to receive updated or newly generated asset development models. As discussed in greater detail below, the model development layer 704 is configured to receive input such as customer preference data 742, offer information data 744, and user-offer interaction data 746 and generate updated and/or new asset prediction models. When new asset prediction models are received from the model development layer 704, the continuous integration pipeline 722 receives the updated and/or new models and prepares them for deployment through deployment engine 724. When a new or updated asset prediction model is received, the deployment engine 724 deploys the new or updated asset prediction model as the current asset prediction model 256e for generating sets of predicted offer assets.

In some embodiments, the model development layer 704 is configured to generate new asset prediction models for prediction, e.g., ranking, a set of offer assets for presentation to a user. The model development layer 704 can include a model training module 730 configured to train one or more asset prediction models. In some embodiments, the model training module 730 is configured to generate context-specific asset prediction models, such as, for example, offer affinity prediction models configured to generate a ranked set of offers having a highest affinity, or likelihood of being accepted or interacted with, for a given user identifier.

The model training module 730 is configured to receive a set of features, such as user-preference features, offer asset features, and/or user-offer interaction features, from a feature store 732. The feature store 732 can include any suitable storage mechanism, such as, for example, database. The feature store 732 can include historical and/or real-time feature data for use in training one or more asset prediction models.

For example, in some embodiments, historical data including user preference data 742 and/or offer information data 744 can be collected in an offline, e.g., not real-time, manner. Similarly, real-time data including user-offer interaction data 746, can be collected in an online, or real-time, manner. The collected data is provided to a datastore. The datastore can include any suitable data storage mechanism, such as a database, configured to store the received customer preference data 742, offer asset information 744, and/or user-offer interaction data 746.

In some embodiments, the collected data, such as the collected customer preference data 742, offer asset information 744, and/or user-offer interaction data 746, is provided to a data validation module 734 configured to perform data validation. For example, the data validation module 734 can be configured to perform data processing and normalization, as discussed above with respect to FIG. 7. As another example, in some embodiments, the data validation module 734 can be configured to verify data type, completeness, and/or values (e.g., within a range of values) of received data.

The validated data is provided to a feature extraction module 736 that is configured to extract and label predetermined features from the validated data. As previously discussed, the features extracted and/or used for each data set, e.g., customer preference data 742, offer asset information 744, and/or user-offer interaction data 746, are selected to provide asset prediction for a user identifier given a set of received assets. In some embodiments, the feature extraction module 736 is configured to extract one or more of a number of transactions feature, an inter-purchase interval feature, an items viewed feature, an add-to-cart feature, a fulfillment intent feature, a total spend feature, and/or any other suitable feature from the customer preference data 742. Similarly, in some embodiments, the feature extraction module 736 is configured to extract one or more of a potential savings feature, an offer level feature, a offer benefit feature, and/or any other suitable feature from the offer asset information 744. As another example, in some embodiments, the feature extraction module 736 is configured to extract a number of asset views feature, a number of asset clicks feature, a number of asset cancels feature, an offer sign-up status feature, and/or any other suitable feature from the user-asset interaction data 746.

After extracting the relevant features, the feature extraction module 736 provides the extracted features to the feature store 732 for storage. As discussed above with respect to FIG. 7, an asset prediction model can be trained based on a set of user preference features, offer asset features, and/or user-offer interaction features. After training, an asset prediction model can be provided to a validation module 738 for model validation. As discussed above with respect to FIG. 7, a model can be validated based on any suitable metrics, such as, for example, impressions for predicted assets, interactions with predicted assets, dismissal of predicted assets, scrolling behavior for an interface including predicted assets, gross merchandise value (GMV) of products purchased through a predicted asset, accuracy of predicted assets, weighted or macro precision of predicted assets, weighted or macro recall of predicted assets, an F or F1 score of the asset prediction model, normalized discounted cumulative gain (NDCG) of the asset prediction model, mean reciprocal rank (MRR) of the predicted assets, mean average precision (MAP) score of the asset prediction model, and/or any other suitable evaluation metrics. In some embodiments, the generated offer affinity asset prediction models are evaluated based on a limited set of evaluation metrics, for example, weighted precision and recall, macro precision and recall, and an F-score. If the generated asset prediction model is validated, it can be provided to the model deployment module 720 for deployment, as discussed above.

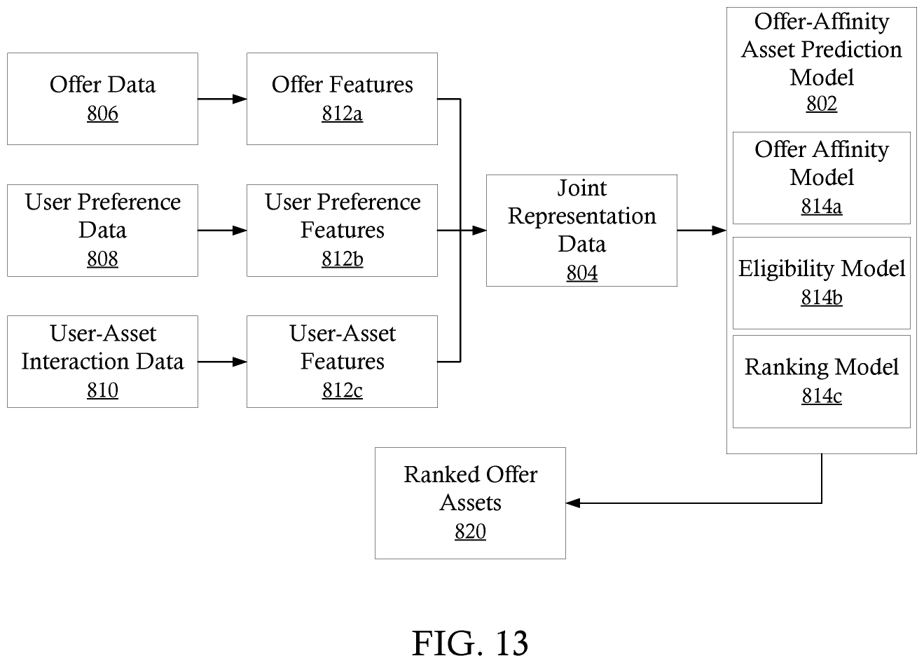

FIG. 13 illustrates a model architecture 800 of a trained offer-affinity asset prediction model 802, in accordance with some embodiments. The trained offer-affinity asset prediction model 802 is similar to the asset prediction models 256-256e previously discussed, and similar description is not repeated herein. In some embodiments, the trained offer-affinity asset prediction model 802 includes a logistic regression model. The logistic regression model is configured to receive a joint representation input 804. The joint representation input 804 can include, for example, an embedding or token representation for a specific user-offer combination. The logistic regression model 802 is configured to receive the joint representation input 804 and generate a set of ranked offer assets 820 based on a probability that a particular user will sign up for a particular offer, e.g., the likelihood of interaction between the user and the offer.

For example, in some embodiments, offer data 806, such as a credit card offer assets including multiple credit offers, are provided. User data 808, such as user preference-data, and user-offer interaction data 810 can also be received. Relevant features, such as offer benefit features 812a, user preference features 812b, and/or user-offer interaction features 812c, can be extracted using any suitable process, such as, for example, a feature extraction module as previously discussed. After extracting relevant features, the offer benefit features 812a, user preference features 812b, and user-offer interaction features 812c are combined using one or more combinatorial process, such as an embedding or tokenization process, to generate the joint representation input 804.

In some embodiments, the trained offer-affinity asset prediction model 802 can include one or more sub-models, such as, for example, a trained offer affinity model 814a, a trained eligibility model 814b, and/or a trained ranking model 814c (referred to collectively herein as “sub-models 814”). Each of the sub-models 814 can be configured to perform a specific step for generating a set of ranked offer assets. For example, in some embodiments, an offer affinity model 814a is configured to perform asset prediction to generate an affinity, or likelihood of interaction, score for each offer asset in the offer data 806. In addition, an eligibility model 814b can be configured to perform an eligibility check to determine if a user associated with the user data 808 is eligible (e.g., meets eligibility criteria) for an offer. If the eligibility model 814b determines that a user associated with the user data 808 is eligible, the affinity scores for each asset generated by the offer affinity model 814a can be provided to a ranking model 814c configured to perform ranking of the offer assets, for example, based on the generated affinity scores and/or additional criteria.

The trained offer-affinity asset prediction model 802 is configured to generate a set of ranked offer assets 820. The set of ranked offer assets 820 can be integrated into and/or presented as part of a generated context-specific interface for a user associated with the user data 808. As discussed above, the ranked offer assets 820 can be presented in a static and/or dynamic (e.g., rotating) fashion. Feedback from offer interactions can be received (as discussed above) and provided to refine trained models and/or train new models for asset prediction, as discussed herein.

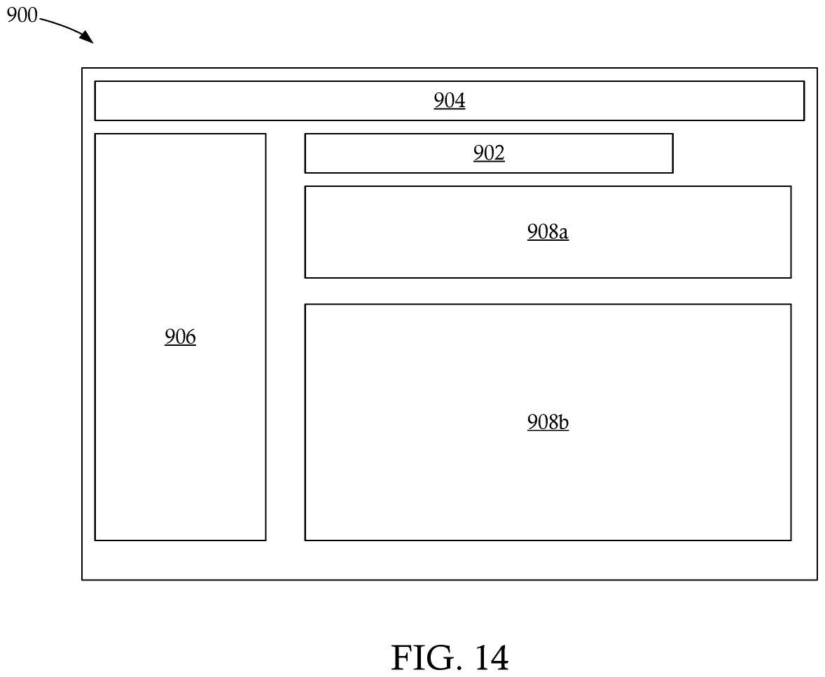

FIG. 14 illustrates a context-specific interface 900 generated by the NBA offer interface architecture 700, in accordance with some embodiments. The context-specific interface 900 is similar to the interface 600 discussed above with respect to FIG. 11, and similar description is not repeated herein. The context-specific interface 900 can include a default, or template, banner element 904 and a context-specific or default sidebar 906. A plurality of context-specific modules 908a, 908b are configured to display predefined context-specific assets to a user. For example, in the context of an accounts page, the context-specific modules 908a, 908b can include a wallet asset (e.g., illustrating payment methods, balances, etc. associated with a user), an account information asset (e.g., an asset configured to provide access to account information such as name, address, account number, etc.), a purchase history asset (e.g., an asset configured to provide access to prior purchase data associated with the user), and/or any other suitable predefined assets.

The context-specific interface 900 includes a context-specific offer asset 902. The context-specific offer asset 902 includes a highest-ranked offer asset selected from a set of offer assets by an asset prediction model, such as, for example, the trained offer-affinity asset prediction model 802 and/or any of the previously discussed asset prediction models 256-256f. In some embodiments, the highest ranked offer asset corresponds to a credit card or other offer that is most likely to be interacted with, e.g., most likely to be signed up for, of the available offer assts.

In various embodiments, the disclosed trained offer-affinity asset prediction models and/or systems including trained offer-affinity asset prediction models are configured to provide time-sensitive, context-specific offer asset predictions for integration into user interfaces. The trained offer-affinity asset prediction models are further configured to integrate feedback information based on user interactions with presented offer assets, including passive feedback such as lack of interaction or failure to accept an offer.

Each functional component described herein can be implemented in computer hardware, in program code, and/or in one or more computing systems executing such program code as is known in the art. As discussed above with respect to FIG. 1, such a computing system can include one or more processing units which execute processor-executable program code stored in a memory system. Similarly, each of the disclosed methods and other processes described herein can be executed using any suitable combination of hardware and software. Software program code embodying these processes can be stored by any non-transitory tangible medium, as discussed above with respect to FIG. 1.

Although the subject matter has been described in terms of exemplary embodiments, it is not limited thereto. Rather, the appended claims should be construed broadly, to include other variants and embodiments, which can be made by those skilled in the art.

What is claimed is:

1. A system comprising:
a non-transitory memory configured to store instructions thereon and a processor which is configured by the instructions to:
receive a user identifier associated with a set of user features;
receive a set of assets each including a set of asset features;
generate a set of predicted assets using a trained asset prediction model, wherein the trained asset prediction model comprises a machine learning model configured to receive the set of user features and the set of asset features for each asset in the set of assets and output the set of predicted assets, and wherein the trained asset prediction model is configured to maximize a likelihood of engagement for the set of predicted assets; and
generate an interface including a predetermined number of assets selected from the set of predicted assets in descending ranked order.

2. The system of claim 1, wherein the trained assert prediction model comprises a random forest model.

3. The system of claim 1, wherein the processor is configured to receive a set of user-asset interaction features, and wherein the trained asset prediction model is configured to receive the set of user-asset interaction features, and wherein the set of predicted assets is selected, in part, based on the user-asset interaction features.

4. The system of claim 3, wherein the set of user-asset interaction features includes a number of views feature, a number of clicks feature, a number of cancels feature, a loyalty program feature, and a tip action feature.

5. The system of claim 4, wherein the loyalty program feature includes an initial enrollment feature and a renewal status feature.

6. The system of claim 1, wherein the trained asset prediction model comprises a context-specific asset prediction model configured to generate a context-specific set of predicted assets for a predetermined interface context.

7. The system of claim 1, wherein the processor is configured to:
receive an asset dismissal for a first asset in the predetermined number of assets, wherein the asset dismissal removes the first asset from the interface;
select a second asset, wherein the second asset includes an asset in the set of predicted assets but not in the predetermined number of assets; and
update the interface to include the second asset.

8. The system of claim 1, wherein the trained asset prediction model is configured to maximize the likelihood of engagement for the set of predicted assets by maximizing a likely click rate for the set of assets.

9. The system of claim 1, wherein the set of user features includes a number of transactions feature, a context affinity feature, an inter-purchase interval feature, an items viewed feature, an add-to-cart feature, and a fulfillment intent feature.

10. A computer-implemented method, comprising:
receiving a set of user features;
receiving a set of asset features for each of a plurality of assets;
executing a trained asset prediction model to generate a set of ranked assets, wherein the trained asset prediction model is configured to receive the set of user features and the set of asset features for each asset in the plurality of assets and output the set of ranked assets, and wherein the trained asset prediction model is configured to maximize a likelihood of engagement for the set of ranked assets; and
generating an interface including a predetermined number of assets selected from the set of ranked assets in descending ranked order.

11. The computer-implemented method of claim 10, wherein the trained asset prediction model comprises a random forest model.

12. The computer-implemented method of claim 10, comprising receiving a set of user-asset interaction features, and wherein the trained asset prediction model is configured to receive the set of user-asset interaction features, and wherein the set of ranked assets is selected, in part, based on the user-asset interaction features.

13. The computer-implemented method of claim 12, wherein the set of user-asset interaction features includes an initial loyalty program enrollment feature and a loyalty program renewal status feature.

14. The computer-implemented method of claim 10, wherein the trained asset prediction model comprises a context-specific asset prediction model configured to generate a context-specific set of ranked assets for a predetermined interface context.

15. The computer-implemented method of claim 10, comprising:
receiving a dismissal notification for a first asset included in the interface;
selecting a second asset, wherein the second asset includes an asset in the set of ranked assets but not in the predetermined number of assets; and
updating the interface to include the second asset.

16. The computer-implemented method of claim 10, wherein the trained asset prediction model is configured to maximize the likelihood of engagement for the set of ranked assets by maximizing a likely click rate for the plurality of assets.

17. A method of training an asset prediction model, comprising:
receiving a set of training data including a set of user-preference features associated with a plurality of user identifiers, a set of asset features associated with a plurality of assets, and a set of user-asset interaction features associated with interactions between the plurality of user identifiers and the plurality of assets;
iteratively modifying one or more parameters of an asset prediction model to minimize a predetermined cost function, wherein the asset prediction model includes balanced weights; and
outputting a trained asset prediction model configured to receive at least one user identifier and a plurality of assets and generate a set of ranked assets.

18. The method of training the asset prediction model of claim 17, wherein minimizing the predetermined cost function includes maximizing a likelihood of interaction between the plurality of users and the plurality of assets.

19. The method of training the asset prediction model of claim 17, wherein the asset prediction model includes a random forest model, and wherein the one or more parameters include a max depth, a minimal samples per leaf, and an n estimators value.

20. The method of training the asset prediction model of claim 17, wherein the set of user-asset interaction features includes an initial loyalty program enrollment feature and a loyalty program renewal status feature.
